(19) United States
(12) Patent Application Publication
(10) Pub. No.: US 2009/0018851 A1
(43) Pub. Date: Jan. 15, 2009

(54) Method and apparatus for arranging business introductions

(76) Inventor: Jeff Greenfield, Wilmington, DE (US)

Correspondence Address: SILLS CUMMIS & GROSS P.C., ONE ROCKEFELLER PLAZA, IP DEPARTMENT - 25TH FLOOR, NEW YORK, NY, 10020, US

(21) Appl. No.: 11/827,920

(22) Filed: Jul. 10, 2007

(51) Int. Cl. G06Q 50/00

(52) U.S. Cl. 705/1

(57) ABSTRACT

A network that uses registration information of multiple parties along with a matching function to match two parties that have a business contact that both parties would benefit from if the parties were introduced. Once found, the network notifies one party that a match has been found. This party is then allowed to either accept or reject an initial introduction without informing the second party. If the introduction is accepted, the second party is then notified that a match has been found and the first party accepted the initial introduction. Now the second party has an opportunity to accept or reject the initial introduction. If accepted the first party is notified that the second party has accepted the introduction and simultaneous messages containing contact information are sent to the first and second parties. The parties then contact each other directly to consummate the initial introduction. Afterwards, the parties will arrange to make formal unsupervised introductions with the business contact.

### BACKGROUND OF THE INVENTION

1. Field of the Invention

The present invention is related to a method for arranging introductions between persons who have specialized business interest. Specifically, it is a method for arranging introductions between parties having similar business interest in a confidential and closed environment allowing the parties to may make preliminary disclosures concerning their proprietary contacts and concepts to each other without jeopardizing the confidentially of such disclosures.

2. Prior Art

One of the key successes to any business is the ability to obtain contacts within an organization which has been targeted as a network referral, client, or funding source. Traditionally, business contacts networked with each other through word of mouth and personal chance meetings contacts. This antiquated method took years to develop and often resulted in missed opportunities and failed ventures because the person or entity seeking the contact could not locate the precise individual or company needed to fulfill the marketing requirements.

With the advent of the Internet, networking has become more robust as people can now have personal contacts and interaction with people they never meet before. But there is a danger to such anonymous interaction. Lack of screening contacts has lead to theft of proprietary information by dishonest contacts, lost time from dead ends and missed opportunities by interacting with people who never had any real interest in your business.

As such, there is a need for a secure Internet environment where business people can network on line in a closed secure environment to locate specific business partners quickly and with greater ease. To date, a system such as this does not exist.

### SUMMARY OF THE INVENTION

There is a need for a method and apparatus that arranges introductions for parties having similar business interest in a secure and closed environment so that the parties may make preliminary disclosures to each other and not jeopardize the confidentially of their identities or the substance of their disclosures.

The present invention satisfies the above-mentioned need by providing an on line, secure network that allows multiple parties to register their personal information, their proprietary and confidential contacts and their proprietary business needs on the network. The parties include “Introducers” and “Seekers.” Introducers are individuals who are willing to make introductions to targeted individuals and entities in exchange for a monetary payment. Seekers are businesses or individuals who are willing to pay for such introductions to targeted individuals or business entities.

These introductions are initialized on a network capable of storing and sorting information pertaining to private businesses and individuals. The network is a secure private environment in a closed network. Although initially screened by the site owner, the identities of the parties are kept confidential. The network identifies only that information which is provided by the Seeker or Introducer pertaining to its business contacts and/or needs, until the parties individually agree to an initial personal introduction.

The network uses a search engine to match two parties that have similar business interest or needs. Once a match is identified, the engine notifies an Introducer that it has located an appropriate Seeker. At the same time, a preliminary statement summarizing the services and costs of the Seeker is presented to the Introducer.

The Introducer may then accept the proposal, accept the proposal with changed conditions or reject the proposal. If the proposal is rejected, the Introducer clicks a ‘REJECT’ button, the search engine notes the rejection and continues its search on behalf of the Introducer and no information is shared with the Seeker. Notably, Seeker is not informed of the identity or the rejection of the proposal. This leaves potential future contacts open between the parties without the history of a rejection.

If the introduction is accepted, the Introducer is required to prepare a brief summary identifying both his desire to meet with the seeker and the specific needs of the Introducer from the contact. Upon receipt of such summary, the search engine removes the identification of the Introducer and notifies the Seeker of the proposed contact providing the summary. The Seeker may then accept the introduction or reject the introduction.

Now, if the Seeker has changed the proposal in any manner, the search engine removes the Seekers identify and sends notification of the changed proposal to the Introducer. This process continues until both the Seeker and the Introducer have accepted a proposal. If the Seeker rejects the initial introduction no further information is shared between the parties. Again, the anonymity of the system leaves open the possibility of future contacts.

If both parties agree to a proposal for an introduction, simultaneous messages containing contact information of the other party are sent to the Introducer and Seeker. The Introducer and Seeker may then contact each other directly and arrange to make formal introductions among themselves to a common business contact.

The formal introductions between Introducer, Seeker and third parties are unsupervised by the network and the parties leave the anonymity and security of the network. This is fully disclosed to each party upon becoming members to the network and at the time the contact information is released. Because the formal introductions are made in an unprotected environment, the network recommends to each party to undertake their own due diligence before the formal introduction. Due diligence includes researching the other parties products, services, reputation and contact information.

The network may also follow up on the parties contact after leaving the networks private and secure environment. The network automatically contacts each party with a questionnaire in which they are asked to rate their respective counterparts on a scaled rating system along with standardized comments these standardized questionnaire are scrutinized by the network to ensure honesty and security within the network. The network retains the right to remove any party from its network at any time. All payments made between the parties for services rendered are made after the parties have left the secure environment of the network.

### BRIEF DESCRIPTION OF THE DRAWINGS

These and other features, aspects, and advantages of the apparatus and methods of the present invention will become better understood with regard to the following description and accompanying drawings where:

FIG. 1 is a block diagram showing a partial view of the network used for registering an Introducer on the network;

FIG. 2 is a block diagram showing a partial view of the network used for registering a Seeker on the network;

FIG. 3 is a block diagram showing the network of the present invention;

FIG. 4 is a flow chart showing the method of arranging business introductions between parties

FIG. 5 is a flow chart showing the method for rating introductions after parties have been introduced.

### DETAILED DESCRIPTION OF THE INVENTION

A method and network for arranging introductions between persons and businesses who have specialized business interest. Specifically, it is a method for arranging introductions between parties having similar business interest in a confidential and closed environment allowing the parties to may make preliminary disclosures concerning their proprietary contacts and concepts to each other without jeopardizing the confidentially of such disclosures.

The parties include “Introducers” and “Seekers.” The Introducers and Seekers are individuals who register on an introduction network by logging on to a website and inputting personal identifiable information about themselves and the business objectives they are attempting to achieve through personal network contacts. There is a registration fee for this service. The fee may be a one-time membership fee, a per search fee and/or a per introduction fee.

Introducers seek to make introductions between parties for monetary payment. That is, Introducers have lists of third party business contacts that they know personally and are willing to schedule an introduction to Seekers for monetary payments or any other compensation they find acceptable.

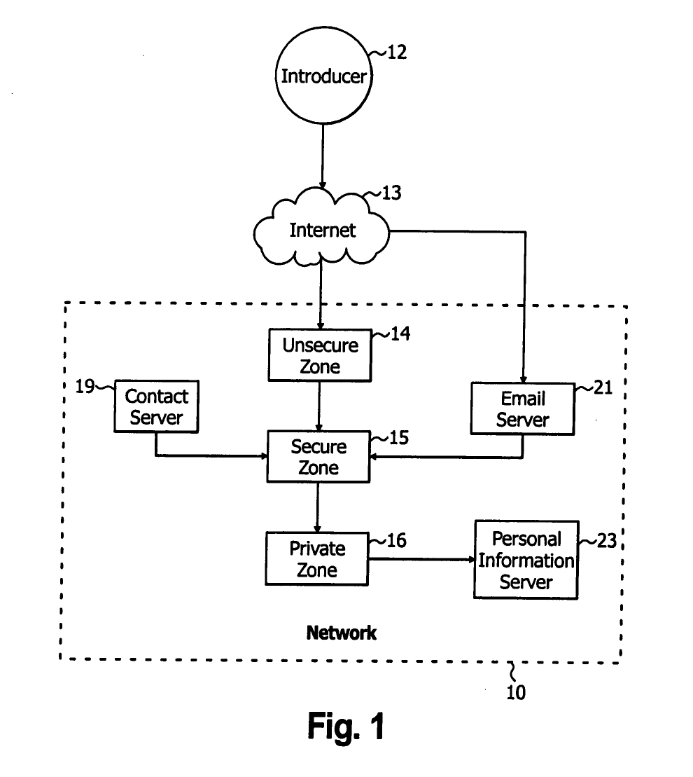

As shown in FIG. 1, a potential introducer 12 first registers on the network 10 by accessing an unsecured and public website 14 of the network 10. The public website 14 contains information pertaining to the basic concept of the network 10 and the steps necessary for registering with the network 10. After reading the content, the potential introducer 12 will be asked to complete a form supplied by the network 10. The form will ask general questions such as the introducer's name, occupation, phone number and e-mail address. Once the form is complete, the potential introducer 12 electronically submits the form to the network 10.

Upon submission, the unsecured network 14 transfers the personal information over a secure network 15. The secure network 15 may only be accessed by to those who have a user ID and password. The information is then transferred to a private network 16 in which only individuals who have administrative access to the network can view the information.

The private network 16 is connected to a personal information server 23. This server 23 is completely secure and is separate from all other parts of the network. The only way the information contained in the personal information server 23 may be accessed is through a single connection between the private network 16 and the secure network 15. After the information is stored, the private network 16 assigns a reference number to the potential introducer 12. This number is used to connect the introducer's personal information with a corresponding list of contacts.

After the network 10 stores the information and assigns a reference number, the private network 16 requests the secure network 15 to send a confirmation e-mail to the potential introducer 12 and supplies the e-mail address to the secure network 15. The e-mail will contain a unique URL link and after the potential introducer 12 receives the e-mail, the potential introducer 12 must confirm the receipt of the e-mail by clicking on the link. Upon entering the link, the potential introducer 12 will be asked to provide a USER ID and password. This completes registration with the network 10 and the USER ID and password are stored on the secure network 15. The newly registered Introducer 12 may now access the secure network 15 at any time.

Specifically, after the registration process is complete, the Introducer 12 becomes a member of the network 10 and may access the secure network 15 using the USER ID and password. The first time the Introducer 12 logs in under the correct user name, the Introducer 12 is asked to set up the account. The information needed by the network 10 is the Introducer's contact list. The contact list may contain personal or business connections with individuals who are affiliated with various companies and industries. These contacts may be reviewed by the network 10 for approval.

The network 10 may provide general industry Categories for the Introducer 12 such as Finance, Automotive, Electronics, etc. Each of these categories will then have subcategories stating a particular company or person. If no category or subcategory exists which matches the contacts areas, the Introducer 12 may ask the network 10 to form a new category and/or subcategory.

All the information regarding the Introducer's contact will be stored in a Contact Server 19. This contact information includes a list of the Introducer's contacts with pertinent information including, but not limited to, the company the contact works for, the stock symbol of the company if appropriate, the industry the company operates in, the level of the contact within the company and the relationship with the contact, e.g. tennis partner, college roommate, brother-in-law etc. The Introducer 12 may also include any other information they believe is relevant for a Seeker 11.

The network 10 may also request more personal information from the Introducer 12. The information may include the company the Introducer works for, his company title and any other information that is the network may deem relevant. This secondary personal information is stored on the Personal Information Server 23 and cannot be accessed by any party other than system administrators.

All information submitted by a member is sent via secure Internet connections allowing all information to be electronically protected on the network 10. Once an Introducer 12 has established a contact list, the Introducer 12 will wait until a match between one of his contacts and a proposed deal of a seeker is found. Once found the secure network 15 will send an e-mail to the Introducer 12 that a match has been found and that the Introducer 12 should log onto the private network for more details.

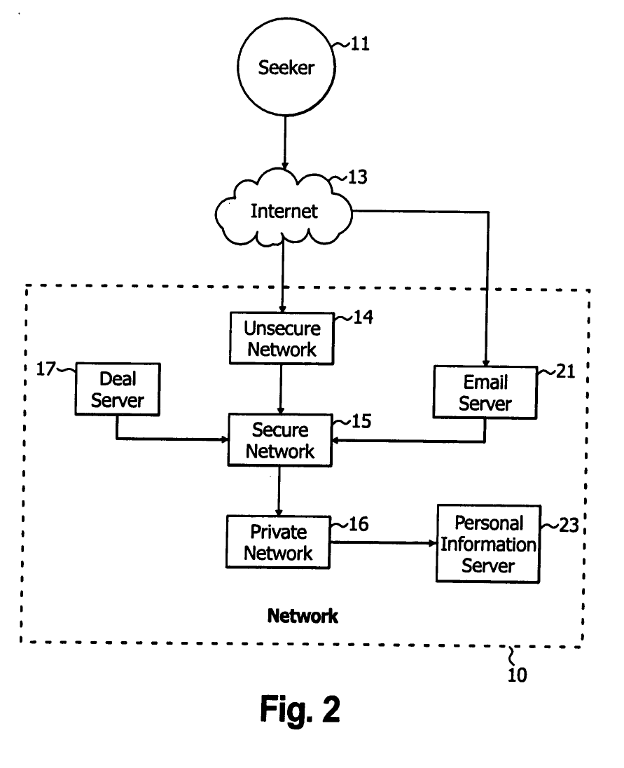

FIG. 2 shows the Seeker registration. In a preferred embodiment, only Seekers 11 requested by the network 10 may join the network 10. (However, it is also contemplated that a seeker may join the network via the unsecured webpage 14.) Specifically, the network 10 receives recommendations from registered introducers and seekers to invite a particular customer to join the network. The invitation is sent by e-mail to a potential seeker 11 and contains a unique URL. This URL opens a registration page for the network 10. Once opened the potential seeker 11 will be asked to register with the network 10. The network 10 will supply the potential seeker 11 with a form that needs to be filled out and submitted to the network 10. The form will ask general personal information of the potential seeker 11. Once electronically submitted the information will be sent over a secure network 15 and then into a private network 16 where the information is stored in the Personal Information Server 23 as discussed above with the Introducer registration. A reference number will then be assigned to the Seeker 11.

Once the initial registration is completed, the network 10 will send a confirmation e-mail to the potential seeker 11 via the e-mail server 21. This e-mail elicits a response via a unique URL link. Once the potential seeker 11 accesses the URL, the registration is confirmed and the Seeker 11 is asked to submit a USER ID and password. This USER ID and password allows the Seeker 11 to access a secure network.

Once registered, the Seeker 11 may access the secure network 15 for the purpose of locating a person that works for a particular company or is in a particular industry. That is, the first time the Seeker 11 logs onto the network 10, the network 10 will ask the Seeker 11 to submit a proposed deal the Seeker 11 wants to present to a contact in a particular company or a particular person in an industry. Examples of proposed deals are financing for business ventures or selling products the Seeker 11 is trying to unload.

When preparing a proposed deal, the Seeker 11 may be required to provide a name to the proposed deal, a preliminary statement summarizing the deal and an expected cost analysis. The Seeker 11 may also name a particular company the Seeker 11 wishes to be introduced to or a particular industry in which he seeks a contact.

The network 10 may provide general industry Categories for the Seeker 11 such as Finance, Automotive, Electronics, etc. Each of these categories will then have subcategories stating a particular company or person. If no category or subcategory exists which matches the Seeker's deal, the Seeker 11 may ask the network to form a new category and/or subcategory.

The Seeker's deal should have sufficient information so that an Introducer 12 may determine from the Seeker 11 if a formal introduction to his/her contact is appropriate. The Seeker 11 may also state the amount he/she is willing to compensate the Introducer 12 for the formal introduction.

Once the deal is composed and reviewed by the network 10, the deal is stored on the Deal Server 17 and the Matching Server 18 will try to locate a match. An e-mail stating that a match is being sought is sent to the Seeker 11 at this time.

The Seeker 11 may access the secure network at any time to check on the status of the deal by accessing the Pending Deal Server 20. The Seeker 11 may also update his proposed deal and/or add new proposed deals to the network 10. Each deal will be assigned a different name. While a match is being located, the Pending Deal Server 20 may have a status identifier of “Seeking Match.”

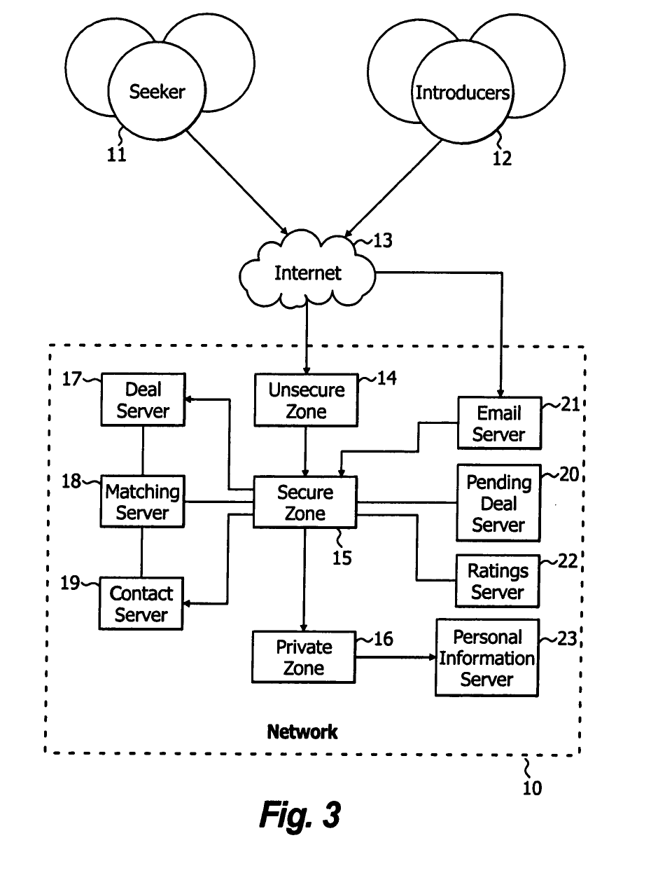

As shown in FIG. 3, the introduction network 10 provides a medium for which Introducers 12 and Seekers 11 can submit confidential information in an anonymous, secure and protected environment so that matches between Introducers 11 and Seekers 12 may occur. That is, the network 10 mostly operates in a closed environment and the identities of the parties are kept confidential until the parties agree to a formal introduction.

The network 10 includes an unsecured network area 14. The unsecured network area 14 is a webpage that informs consumers the concept behind the website and its functions. These webpages are available to the public and do not contain any confidential information. If a consumer would like to join the network 10 there are links to forms that need to be filled out as explained above.

After the consumer has registered with the network 10, the customer will either get a Seeker ID and password or an Introducer ID and password depending on the situation the consumer is in. After the ID and password are given to the customer, the Introducer/Seeker 12, 11 will sign onto a secure network 15.

The secure network 15 includes multiple servers. These servers include an E-mail Server 21, a Deal Server 17, a Contact Server 19, a Matching Server 18, a Pending Deal Server 20 and Ratings Server 22. The secure network 15 is also connected to a private network 16 which in turn is connected to a Personal Information Server 23 that protects the private information of the Seekers/Introducers 12, 11.

The Deal Server stores deals created by the Seekers 11. The Seeker 11 will input information about the proposed deal such the contacts he would like to make and a brief summary of the deal. The information that is stored in the Deal Server 17 is all non-confidential information that may be shared with Introducers 12. The Deal Server 17 does not store any personal, private or confidential information. The reference number assigned to Seeker 11 of the proposed deal is the only information the Introducer(s) 12 will see about the Seeker 11. The Introducer 12 does not have access to the Personal Information Server 23 and cannot find out who the Seeker 11 is. The only information provided to an Introducer 12 is that of the proposed deal stored in the Deal Server 17.

Only Seekers 11 with a Seeker ID and number are allowed to write information to the Deal Server 17. The device, however, contemplates allowing all registered members to view the Deal Server 17.

The Contact Server 19 stores contact lists of the Introducers 12. The list is a general contact list and does not have any proper names for the contact themselves. The Contact Server 19 stores non-personal information about each contact such as what company they are affiliated with and level they are within a company. Each contact is associated with the reference number of the Introducer 12.

Only Introducers 12 with an Introducer ID and password may write into the Contact Server 19. The network 10, however, contemplates allowing all registered members to view the Contact Server 19.

The Matching Server 18 matches proposed deals stored in the Deal Server 19 with contacts contained on the Contact Server 19. The matching function can be done by contact name, contact company or any other way in which the deal matches a contact's credentials. As discussed above, the information may include a name of the company, business connections, the industry of the organization, a contact person, the type of business venture, the area of specialty and any other pertinent information that will assist the network 10 in performance of the search.

The Matching Server 18 will automatically match the criteria of the Seeker's deal with the contacts of the Introducers. That is, when the Seeker enters all the necessary information, the network will automatically search the contact database for a matching Introducer 12.

While the matching function is being performed, the Seeker 11 may be able to track his proposal on the Pending Deal Server 20. That is, the seeker may access the Pending Deal Server 20 and check on the status of the deal. While the search is being performed the Pending Deal Server 20 may give a status such as “PENDING.”

In most cases, a Seeker 11 will usually receive a response to his proposed deal in one to five days depending if an Introducer 12 is found and is able to be contacted. But if after two weeks or some other finite amount of time, a match is not found, the status message may be changed to “No match Found—Search Still Pending.” This means that no match is found at this time but the network 10 will search any new contact that is added to the network 10.

Once a match is found, the Matching Server 18 will request that an e-mail be sent via the E-mail Server 21 to the Introducer(s) 12 that matched the proposed deal of the Seeker 11. The Matching Server 18 does not have the e-mail address of the Introducer 12 so the Matching Server 18 will send the reference number of the matching introducer 12 to the secure network 15. The secure network will then send the reference number to the private network 16. The private network 16 will match the reference number to the corresponding Introducer 12 and retrieve the Introducer's e-mail address. The private network 16 will then transmit an e-mail address to the secure network 15 and the secure network 15 will transmit the e-mail. The e-mail will most likely contain a message informing the Introducer 12 to check the Pending Deal Server 20 for a specific proposed deal and may also contain the deal summary prepared by the Seeker 11.

The Pending Deal Server 20 updates the status of pending deals. At each stage of the introduction process, the Pending Deal Server 20 will change the status of the deal. The Introducers 11 and Seekers 12 all have access to this server 20 and may look at pending deals they are involved in. The Introducers 11 and Seekers 12 may not access deals they are not privy to.

The E-mail Server 21 sends notifications to the Introducers 12 and Seekers 11 when matches are found, when individuals are trying to register on the network and for any other reason the network 10 must contact a registered party. The e-mails are sent from the secure network 16 and cannot be accessed by any registered party. Only system administrators can access the E-mail server.

The Ratings Server 22 stores reviews of Introducers 12 and Seekers 11. The rating scores can be viewed by all registered members and allows the Introducer 12 and/or Seeker 11 an opportunity to see if past introductions were worthwhile. The process for obtaining the review information is discussed below.

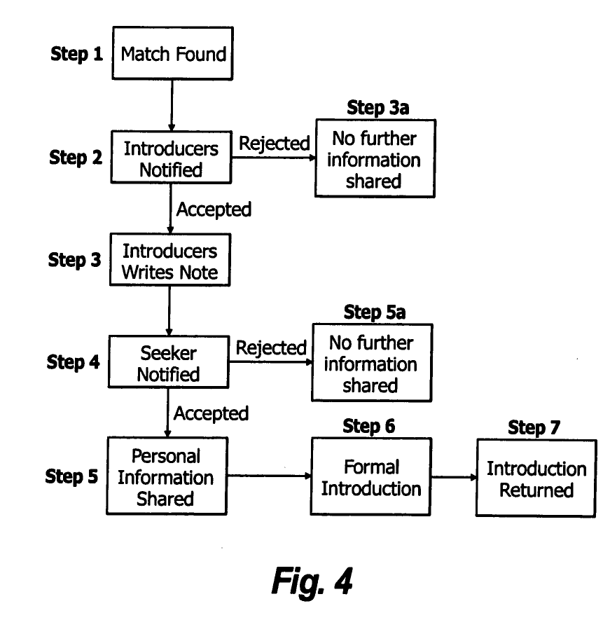

The method of the present invention is shown in FIG. 4. Once a match has been found between a Seeking party and an Introducer (Step 1), the engine notifies an Introducer about the match via email. More than one Introducer may be notified if several matches are found but for ease of understanding the invention only one contact will be notified. In the notification, the network will ask the Introducer to check the status of his account and may provide to the Introducer the information provided by the Seeker. This may include, for example, a preliminary statement and/or a proposed deal (Step 2). This information typically does not include any private personally identifiable information of the Seeker, including the Seekers name, title or company.

After the Introducer accesses the secure network, the Introducer may view the full details of the proposed deal. The Introducer is then allowed to accept, reject, or accept the proposal with changes. If accepted, the Introducer may be required to write a brief summary typically identifying both his desire to meet with the Seeker and the specific needs of the Introducer (Step 3). If rejected, the Introducer simply clicks a ‘REJECT’ button and no information is shared with the Seeker and the Seeker is not informed of the Introducer's rejection (Step 3a). During this stage the Seeker is not notified about the found match.

After the proposal has been accepted, the Seeker is notified via e-mail that a match has been found and is asked to access the account. After the Seeker logs onto the system the Seeker will view the Introducers summary (Step 4). If more than one Introducer accepted, the Seeker would receive each Introducers' Summary and the Seeker may choose which Introducer(s) with whom to interact. The pending deal server status may now display a status of “MATCH FOUND.” If no match is found the system may display a status of “NO MATCH.”

The Seeking party now has an opportunity to review details of the introduction and accept, reject or accept with proposed changes. In choosing the Introducer it is preferred that the Seeker has an opportunity to review any past deals of the Introducer if such reviews were present on the network. These reviews would be stored in the Ratings Server and may be accessed at anytime by the Seeker.

If the Seeker rejects the introduction no further information is shared between the parties (Step 5a). If the Seeker accepts, the Introducer is notified that the Seeker has accepted the introduction. The secure network will request the private network to release the personal information of the introducer and seeker. Simultaneous e-mail messages containing contact information for the introducer and seeker are then sent to both parties (Step 5). These parties then contact each other directly and arrange formal introductions (Step 6).

It is preferred that the network is no longer connected to parties at this time and the formal introductions are unsupervised by the network. As such, the formal introductions are made in an unprotected environment and the network recommends each party undertake do due diligence on the other party before the formal introduction. Due diligence includes researching the other parties products, services, reputation and contact information. Typically, any payments made between the parties takes place after the formal introductions and after the network's involvement has ended.

After the parties have made their formal introductions (usually seven to ten days), the parties may be asked to rate their respective counterparts on a scaled rating system along with standardized comments (Step 7). These comments are reviewed by the network and posted to provide future parties with insight into whether or not a particular party was good, bad or adequate.

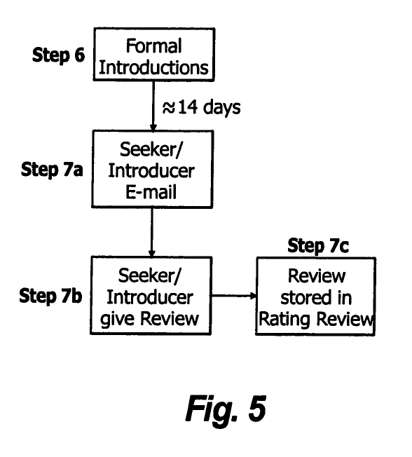

FIG. 5 shows the method for the review process. After a given time period such as 14 days an e-mail is sent to the Seeker and Introducer asking for a rating of the introduction (Step 7a). The network requests information such as the deal name, deal overview and if a connection was made. The Seeker/Introducer inputs the rating and may also include any additional comments (Step 7b). These rating are stored on a rating database and may be assessed by users on the secure network (Step 7c).

An example of the method is as follows. A seeker is a chef who wants to open his own restaurant—Chef P. The food to be served in the restaurant is his own recipes that he developed over the years. Chef P has insufficient capital of his own and does not have any business contacts. The Chef P would like to be introduced to the owner of Restaurant A.

Restaurant A is the best restaurant in the San Diego area and the owner has previously helped upcoming chefs find financing for new restaurants. Chef P registers on the network for a fee. Chef P then prepares a preliminary statement requesting an introduction to the owner of Restaurant A or someone who works closely with the owner and proposes a monetary amount Chef P will pay for an introduction.

An Introducer, Introducer X, is highly entrenched in the restaurant industry and knows many companies, their owners and representatives. Introducer registered on network and submitted all of his business contacts to the engine. One of Introducers contacts is the owner of Restaurant A.

The network matched Chef P with Restaurant A via Introducer X's contact list. After the network made the match, the engine notified Introducer X that a Seeker is looking for an introduction to the owner of Restaurant A because the Seeker wants to open a high-end restaurant in New York and is willing to pay $25,000 for an introduction. Introducer X is not given Chef P's name or any confidential details.

Introducer X after reviewing the preliminary statement can accept, accept with changes or reject the introduction. If rejected Chef P's information remains in the network and Chef P is never notified that Introducer X reviewed his proposal. No information is shared between the parties.

If Introducer X accepts the deal, Introducer X will write a short note to Chef P. The note may include the chances that an introduction will take place.

Chef P receives the note and the relationship the introducer has with the contact at Restaurant A. Chef P is given an opportunity to accept or reject Introducer X's initial introduction. If rejected both parties remain in the network and no further information is shared. If accepted Introducer X is notified of the acceptance and both parties will receive the contact information of the other so that they may contact each other directly.

Once contacted the parties may or may not agree to make formal introductions. If a formal introduction is accepted, Introducer X will introduce Chef P to the owner of Restaurant A. After the introductions are made, Chef P and Introducer A may revisit the network and rate the quality of the introduction. The $25,000 payment for the introduction will be made to Introducer X after the formal introduction is made and after the involvement with the introduction network has ended.

Although the method and apparatus of the present invention has been described in detail and with particularity, it will be appreciated by those skilled in the art of networking those changes and modifications may be made therein without departing from the scope and spirit of the invention.

What is claimed:

1. A method for arranging an introduction between a seeking party and a potential business contact, the potential business contact being provided by an introducing party, the method comprising the steps of:
allowing at least one seeking party and at least one introducing party to register on an introduction network, the introduction network storing at least one contact of the introducing party and at least one proposed deal of the seeking party;
automatically matching a first proposed deal of the at least one seeking party with a first contact of the at least one introducing party;
notifying the introducing party that a match has been found;
allowing the introducing party to review the first proposed deal;
allowing the introducing party to accept the first proposed deal and to offer an initial introduction to the seeking party;
notifying the seeking party that a match has been found and the introducing party offered the initial introduction;
allowing the seeking party to accept the initial introduction;
notifying the introducing party that the seeking party accepted the initial introduction;
sending the initial introduction to the seeking party and the introducing party, the initial introduction including the seeking party's and the introducing party's contact information; and
allowing the seeking party and the introducing party to arrange a formal introduction with the first contact.

2. The method of claim 1 whereby the first contact is a personal and/or business contact of the at least one introducing party.

3. method of claim 1 whereby the proposed deal includes information pertaining to a company the seeking party wants to be introduced to and/or an industry that the proposed deal relates to.

4. The method of claim 1 whereby the introduction network is a private environment in a closed network.

5. The method of claim 1 whereby identities of the seeking and introducing parties are kept private until the parties agree to the initial introduction.

6. The method of claim 1 whereby identities of the contacts are kept private until the parties agree to the formal introduction.

7. The method of claim 5 whereby the introducing party seeks to make the formal introduction for monetary payment.

8. The method of claim 6 whereby the seeking party seeks to pay the introducing party for the formal introduction.

9. The method of claim 1 further comprising the step of:
accessing the introduction network via the internet.

10. The method of claim 1 further comprising the step of:
allowing the introducing party to reject the proposed deal.

11. The method of claim 9 whereby if rejected, the introducing party clicks a ‘REJECT’ button and no information is shared with the seeking party.

12. The method of claim 9 whereby if rejected, the seeking party is not informed that the introducing party rejected the deal.

13. The method of claim 1 whereby if accepted, the introducing party is required to write a short note expressing the introducing party's desire for the initial introduction.

14. The method of claim 12 whereby the note does not includes personal details.

15. The method of claim 1 further comprising the step of:
allowing the seeking party to reject an introduction.

16. The method of claim 1 further comprising the step of:
providing the seeking party an opportunity to review details of the short note.

17. The method of claim 1 whereby the formal introductions are made in an unprotected environment.

18. The method of claim 1 whereby the seeking and introducing parties are recommended to do due diligence on the other party.

19. The method of claim 1 whereby after the parties have had formal introductions, the parties are asked to rate their respective counterparts on a scaled rating system along with standardized comments.

20. The method of claim 1 whereby payments made between the parties takes place between the parties after the introduction network's involvement has ended.

21. The method of claim 1 whereby the formal introduction is unsupervised by the introduction network.

22. A network that arranges introductions between seeking parties and potential business contacts, the potential business contacts being provided by introducing parties, the network comprising:
a contact server for storing contact information relating to at least contact of at least one introducer;
a deal server for storing deal information relating to at least one proposed deal of at least one seeker; and
a matching server for matching deal information with contact information; and
an e-mail server for notifying the at least one introducer and the at least one seeker that a match has been found.

23. The network of claim 22 further comprising:
a personal information server for storing personal information relating to the at least one seeker and the at least one contact.

24. The network of claim 22 further comprising:
an unsecure network area for allowing the public to view information regarding the network.

25. The network of claim 22 further comprising:
a secure network area, the secured network area being connected the contact server and the deal server, the secure network allowing only registered members to read and write information to the deal and the contact servers.

26. The network of claim 22 further comprising:
a private network area being connected to the personal information server for protecting the personal information from being viewed by registered members.

27. The network of claim 22 further comprising:
a ratings server for storing reviews of past introductions between the registered members.

28. The network of claim 22 further comprising:
a pending data server for allowing the register members to view the status of pending deals.
